(19) United States
(12) Patent Application Publication
(10) Pub. No.: US 2022/0398473 A1
(43) Pub. Date: Dec. 15, 2022

(54) COMPUTER SYSTEM, INFERENCE METHOD, AND NON-TRANSITORY MACHINE-READABLE MEDIUM

(71) Applicant: Hitachi, Ltd., Tokyo (JP)

(72) Inventors: Kenta KANAI, Tokyo (JP); Masayuki MOROHASHI, Tokyo (JP); Akira MATSUMOTO, Tokyo (JP)

(73) Assignee: Hitachi, Ltd., Tokyo (JP)

(21) Appl. No.: 17/696,049

(22) Filed: Mar. 16, 2022

(30) Foreign Application Priority Data
Jun. 15, 2021 (JP) 2021-099156

(51) Int. Cl. G06N 5/04; G06F 16/22

(52) U.S. Cl. CPC G06N 5/046; G06F 16/2272

(57) ABSTRACT

A computer system manages a data set of learning data. The computer system is configured to: generate, in a case where a plurality of pieces of input data including the value of the explanatory variable and forming a time series are received, groups by arranging a plurality of pieces of the learning data in time-series order and grouping the plurality of pieces of the learning data in predetermined time widths; execute, for each of a plurality of the groups, index calculation processing of calculating a selection index of sampling of the learning data; select the plurality of pieces of the learning data from the data set based on the selection index; learn the model by using the selected plurality of pieces of the learning data; and output a predicted value of each of the plurality of pieces of input data by using the model.

### CLAIM OF PRIORITY

The present application claims priority from Japanese patent application JP 2021-99156 filed on Jun. 15, 2021, the content of which is hereby incorporated by reference into this application.

### BACKGROUND OF THE INVENTION

This invention relates to a technology for sampling learning data to be used to learn a model.

There is a system which utilizes a model that selects an action for improving a KPI in order to maximize profit and achieve operational efficiency. The model is generated by reinforcement learning using learning data including values relating to a state and an action.

Machine learning using a very large amount of learning data is known to take a very long processing time. Therefore, in order to perform efficient processing, sampling to narrow down the learning data is performed. Examples of methods of sampling learning data include random sampling and the technology as described in JP 2009-104632 A.

In JP 2009-104632 A, it is described that “An active learning system samples known data, and learns the known data independently in a plurality of learning machines, and selects data to be next learned for unknown data. The active learning system includes a sampling weighting device for weighting the known data when known data is sampled, a prediction weighting device for weighting learning results of the plurality of learning machines when the learning results are integrated, and a data weighting device for weighting the learning results when the data to be next learned is selected. When an extreme deviation is present on the count of data, each of the weighting devices more heavily weights a larger count of data.”

### SUMMARY OF THE INVENTION

In JP 2009-104632 A, a general-purpose model is generated because the weighting to be used as a sampling selection index is not determined in consideration of unknown data. Therefore, there is a fear in that unknown data having greatly different characteristics from the past due to occurrence of, for example, a sudden event, a seasonal change, or a periodic change, may not be accurately inferred.

An object of this invention is to implement machine learning including sampling which considers unknown data.

A representative example of the present invention disclosed in this specification is as follows: a computer system comprises at least one computer including a processor, a storage device coupled to the processor, and an interface coupled to the processor. The computer system is configured to manage a data set of learning data including a value of an explanatory variable and a value of a response variable, and a model for outputting a predicted value of the response variable from the value of the explanatory variable. The at least one computer being configured to: generate, in a case where a plurality of pieces of input data including the value of the explanatory variable and forming a time series are received, groups by arranging a plurality of pieces of the learning data included in the data set in time-series order and grouping the plurality of pieces of the learning data in predetermined time widths; execute, for each of a plurality of the groups, index calculation processing of calculating a selection index of sampling of the learning data; select the plurality of pieces of the learning data from the data set based on the selection index; learn the model by using the selected plurality of pieces of the learning data; and output a predicted value of each of the plurality of pieces of input data by using the model. The at least one computer is configured to, in the index calculation processing: calculate the selection index based on a similarity between a distribution characteristic in a feature amount space of the plurality of pieces of input data and a distribution characteristic in the feature amount space of the plurality of pieces of the learning data included in the group; and add the selection index to each of the plurality of pieces of the learning data included in the group.

According to the at least one embodiment of this invention, the machine learning including the sampling which considers input data (unknown data) can be implemented. As a result, it is possible to efficiently generate the model having a high inference accuracy for the input data (unknown data) to be inferred. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating an example of a functional configuration of a computer system according to a first embodiment of this invention;

FIG. 2 is a diagram for illustrating an example of a hardware configuration of a computer included in the computer system according to the first embodiment;

FIG. 3A, FIG. 3B, and FIG. 3C are diagrams for illustrating an example of data structure of data to be handled by the computer system of the first embodiment;

FIG. 4 is a flowchart for illustrating an outline of processing to be executed in a case where the computer system of the first embodiment receives input data group;

FIG. 5 is a flowchart for illustrating an example of preprocessing to be executed by a preprocessing module in the first embodiment;

FIG. 6A and FIG. 6B are diagrams for illustrating a concept of the processing to be executed by the preprocessing module in the first embodiment;

FIG. 7 is a flowchart for illustrating an example of learning processing to be executed by a learning module in the first embodiment;

FIG. 8 is a flowchart for illustrating an example of inference processing to be executed by an inference module in the first embodiment; and

FIG. 9 is a flowchart for illustrating an example of action result obtaining processing to be executed by an action result obtaining module in the first embodiment.

### DETAILED DESCRIPTION OF THE PREFERRED EMBODIMENTS

Now, a description is given of an embodiment of this invention referring to the drawings. It should be noted that this invention is not to be construed by limiting the invention to the content described in the following embodiment. A person skilled in the art would easily recognize that a specific configuration described in the following embodiment may be changed within the scope of the concept and the gist of this invention.

In a configuration of this invention described below, the same or similar components or functions are assigned with the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and other metrics in order to facilitate understanding of this invention. Thus, this invention is not limited to the position, size, shape, range, and others described in, for example, the drawings.

### First Embodiment

There is now given description of a computer system which executes machine learning including sampling in consideration of input data to be inferred.

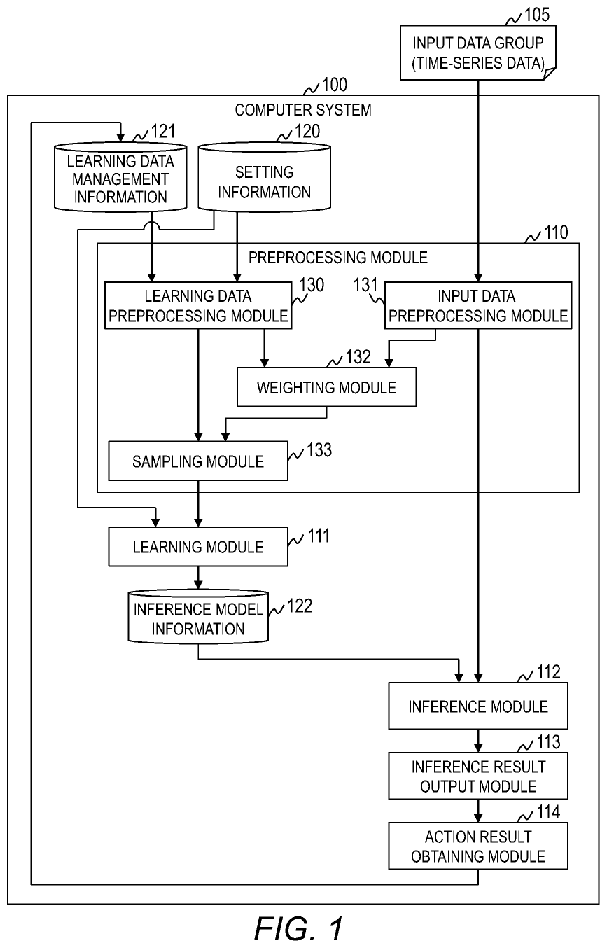

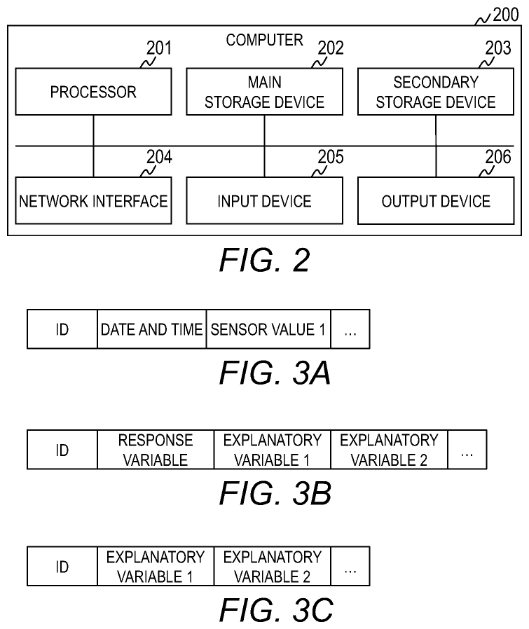

FIG. 1 is a diagram for illustrating an example of a functional configuration of a computer system according to a first embodiment of this invention. FIG. 2 is a diagram for illustrating an example of a hardware configuration of a computer included in the computer system according to the first embodiment.

A computer system 100 is built from at least one computer 200. The computer 200 includes a processor 201, a main storage device 202, a secondary storage device 203, a network interface 204, an input device 205, and an output device 206. Each hardware element is coupled to each other via an internal bus.

The processor 201 executes programs stored in the main storage device 202. The processor 201 operates as a function unit (module) which implements a specific function by executing processing in accordance with the programs. In the following description, when processing is described with the function unit as the subject of the sentence, this indicates that the processor 201 executes a program for implementing the function unit.

The main storage device 202 is a dynamic random access memory (DRAM), for example, and stores the programs executed by the processor 201 and the data used by the programs. The main storage device 202 is also used as a work area.

The secondary storage device 203 is, for example, a hard disk drive (HDD) or a solid state drive (SSD), and stores data permanently. The programs and data stored in the main storage device 202 may be stored in the secondary storage device 203. In this case, the processor 201 reads out programs and data from the secondary storage device 203, and loads the read programs and data onto the main storage device 202.

The network interface 204 is an interface for coupling to an external apparatus via a network. The input device 205 is, for example, a keyboard, a mouse, or a touch panel. The input device 205 inputs data and commands to the computer 200. The output device 206 is, for example, a display, and outputs processing results, for example.

The computer system 100 may include a storage system, a network switch, and the like.

The computer system 100 includes a preprocessing module 110, a learning module 111, an inference module 112, an inference result output module 113, and an action result obtaining module 114. The computer system 100 also holds setting information 120, learning data management information 121, and inference model information 122.

The setting information 120 stores information on calculation processing of a weighting which is a selection index of sampling of learning data and information on learning processing. The learning data management information 121 stores learning data. The inference model information 122 stores an inference model for performing an inference by using input data.

The preprocessing module 110 generates data having a data format to be handled in the learning processing and inference processing. The preprocessing module 110 also samples the learning data to be used in the learning processing. The preprocessing module 110 includes a learning data preprocessing module 130, an input data preprocessing module 131, a weighting module 132, and a sampling module 133.

The learning data preprocessing module 130 converts the learning data to the data format to be handled by the learning module 111. The learning data preprocessing module 130 outputs the learning data to the weighting module 132 and the sampling module 133.

The input data preprocessing module 131 receives an input data group 105 to be inferred, and converts the input data group 105 to the data format to be handled by the inference module 112. The input data preprocessing module 131 outputs the input data to the weighting module 132 and the inference module 112.

The weighting module 132 calculates a weighting, and outputs the weighting to the sampling module 133. The sampling module 133 executes sampling of the learning data based on the weighting, and outputs the selected learning data to the learning module 111.

The learning module 111 generates an inference model by executing learning processing by using the learning data selected by the sampling module 133. The learning module 111 stores the inference model in the inference model information 122. In the first embodiment, the learning module 111 generates an inference model (strategy) for selecting an action from an environmental state by performing reinforcement learning.

In this invention, the learning method is not limited. Further, in this invention, the type and structure of the inference model are not limited. In addition, in this invention, the matter to be inferred is not limited.

The inference module 112 obtains one inference result by inputting one piece of input data to the inference model. The inference result output module 113 outputs the inference result. The action result obtaining module 114 obtains the actual action and the environmental state after the action is performed, and stores the obtained actual action and environmental state in the learning data management information 121 as the learning data.

Regarding the various function modules included in the computer system 100, a plurality of function modules may be grouped into one function module, or one function module may be divided into a plurality of function modules for each function. Further, when the computer system 100 is built from a plurality of computers 200, the various function modules may be distributed and arranged in the plurality of computers 200.

FIG. 3A, FIG. 3B, and FIG. 3C are diagrams for illustrating an example of data structure of the data to be handled by the computer system 100 of the first embodiment.

In FIG. 3A, there is illustrated the data structure of the learning data stored in the learning data management information 121. The learning data includes a learning data ID, a date and time when the environmental state is observed, a value indicating the environmental state, and a value indicating the action.

In FIG. 3B, there is illustrated the data structure of the learning data converted by the learning data preprocessing module 130. The learning data includes the learning data ID, a value of a response variable, and a value of an explanatory variable. In the first embodiment, the value of the response variable is calculated from the value indicating the action, and the value of the explanatory variable is calculated from the value indicating the environmental state. The date and time may be included in the explanatory variable, or may not be included in the explanatory variable.

In FIG. 3C, there is illustrated the data structure of the input data converted by the input data preprocessing module 131. The input data includes an input data ID and a value of an explanatory variable. The input data received by the computer system 100 includes the ID, the date and time when the environmental state is observed, and a value indicating the environmental state.

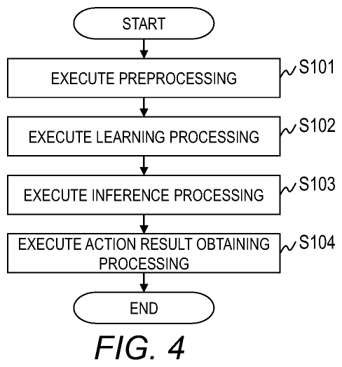

FIG. 4 is a flowchart for illustrating an outline of processing to be executed in a case where the computer system 100 of the first embodiment receives the input data group 105.

In a case where the computer system 100 receives the input data group 105 including input data arranged in time-series order, the following processing is started.

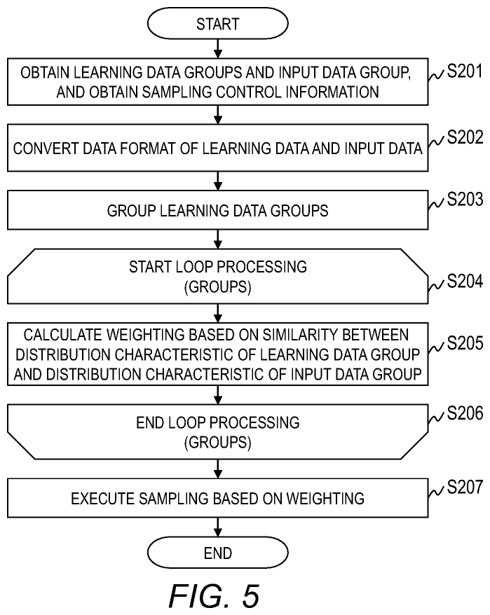

The preprocessing module 110 of the computer system 100 executes preprocessing (Step S101). The details of the preprocessing are described with reference to FIG. 5.

Next, the learning module 111 of the computer system 100 executes learning processing (Step S102). The details of the learning processing are described with reference to FIG. 7.

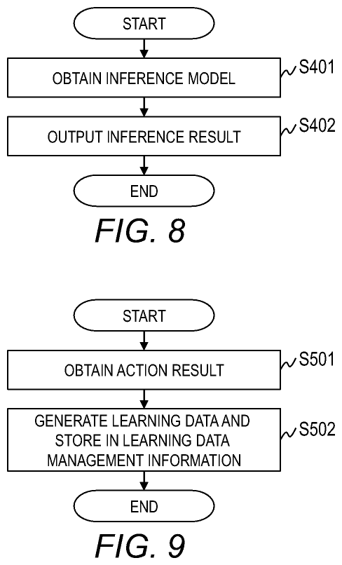

Next, the inference module 112 of the computer system 100 executes inference processing (Step S103). The details of the inference processing are described with reference to FIG. 8.

Next, the action result obtaining module 114 of the computer system 100 executes action result obtaining processing (Step S104), and ends the series of processing steps. The details of the action result obtaining processing are described with reference to FIG. 9.

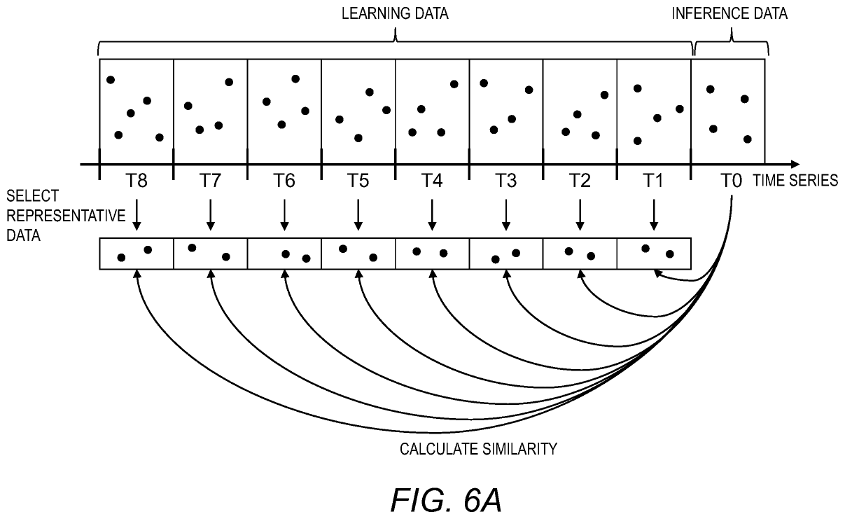

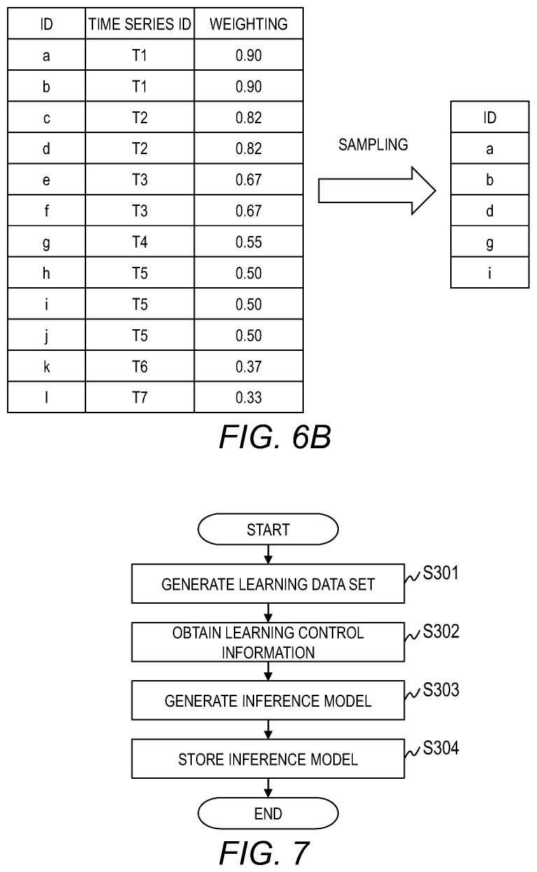

FIG. 5 is a flowchart for illustrating an example of preprocessing to be executed by the preprocessing module 110 in the first embodiment. FIG. 6A and FIG. 6B are diagrams for illustrating a concept of the processing to be executed by the preprocessing module 110 in the first embodiment.

The preprocessing module 110 obtains learning data groups from the learning data management information 121, obtains the received input data group 105, and also obtains sampling control information from the setting information 120 (Step S201).

Specifically, the learning data preprocessing module 130 obtains learning data groups and sampling control information, and the input data preprocessing module 131 obtains the input data group 105. The sampling control information includes a number of samples (pieces of learning data) to be selected, an algorithm for selecting representative learning data, and a weighting calculation algorithm.

Next, the preprocessing module 110 converts the data format of the learning data and the input data (Step S202).

Specifically, the learning data preprocessing module 130 converts the data format of each piece of learning data included in the learning data groups, and the input data preprocessing module 131 converts the data format of each piece of input data included in the input data group 105. Conversion of data formats is a known technology, and therefore a detailed description thereof is omitted here.

Next, the preprocessing module 110 groups the learning data groups (Step S203).

Specifically, the weighting module 132 generates groups by arranging the learning data in a time-series order and grouping the learning data in any time width. In a case where the explanatory variable of the learning data does not include the date and time, the learning data preprocessing module 130 outputs the learning data arranged in the time-series order.

For example, as illustrated in FIG. 6A, the weighting module 132 generates groups by grouping pieces of learning data in the same time width as the time width of the input data group 105. The longitudinal direction indicates a feature amount space. The weighting module 132 adds identification information T0 on the time series to the input data groups. The weighting module 132 also adds identification information on the time series to groups of learning data. In FIG. 6A, pieces of identification information of from T1 to T8 are added in order of going back in time.

Next, the preprocessing module 110 starts loop processing of the groups (Step S204).

Specifically, the weighting module 132 selects one group from among the generated groups. In this example, the groups are selected in order of going back in time. In the example illustrated in FIG. 6A, the groups are selected in order of T1, T2, T3, T4, T5, T6, T7, and T8.

Next, the preprocessing module 110 uses the representative learning data and the input data group 105 to calculate the weighting of the groups based on a similarity between a distribution characteristic of the learning data groups included in the groups and a distribution characteristic of the input data group 105 (Step S205).

The distribution characteristic of the learning data groups represents a characteristic of the distribution of the learning data in the feature amount space, and the distribution characteristic of the input data group 105 represents the characteristic of the distribution of the input data in the feature amount space. The following three methods may be considered as the method of calculating the weighting.

(Calculation Method 1) The weighting module 132 calculates the weighting by using Expression (1).

$$w = exp ( - \frac{t}{β} ) \qquad ( 1 )$$

In the expression, w represents the weighting, β represents any constant, and t represents a time series distance of the group. For example, in a case where the identification information on the time series of the group is T1, t is 1, and in a case where the identification information on the time series of the group is T6, t is 6. Calculation Method 1 is a method of calculating the weighting based on the assumption that as the time difference with respect to the input data group becomes smaller, the distribution characteristic of the learning data group becomes more similar to the distribution characteristic of the input data group 105.

As illustrated in FIG. 6B, the weighting module 132 applies the calculated weighting to each piece of learning data included in the group.

(Calculation Method 2) The weighting module 132 selects the representative learning data from the learning data included in the group based on the algorithm for selecting the representative learning data. The weighting module 132 analyzes, for example, the distribution of the learning data in the feature amount space and selects a predetermined number of pieces of learning data that are close to the center of the distribution. As another example, the weighting module 132 randomly selects a predetermined number of pieces of learning data. In this invention, the method of selecting the representative learning data is not limited.

The weighting module 132 generates a pair of representative learning data and input data. The weighting module 132 calculates a correlation coefficient by using the value of the explanatory variable of each pair. The weighting module 132 calculates the average value of the correlation coefficient as the weighting.

As illustrated in FIG. 6B, the weighting module 132 applies the calculated weighting to each piece of learning data included in the group.

(Calculation Method 3) The weighting module 132 selects the representative learning data from the learning data included in the group based on the algorithm for selecting the representative learning data.

The weighting module 132 generates a model for classifying the learning data and the input data by using the representative learning data group and the input data group 105. Specifically, the weighting module 132 learns the model by using learning data having a correct answer label of “0” assigned thereto and input data having a correct answer label of “1” assigned thereto. The model outputs a probability value at which the data to be classified is an input model. The weighting module 132 obtains a predicted value by inputting the representative learning data to the model. The weighting module 132 calculates the average value of the predicted value of each piece of learning data as the weighting.

As illustrated in FIG. 6B, the weighting module 132 applies the calculated weighting to each piece of learning data included in the group.

In a case where the weighting of Calculation Method 1 is used, the learning data is preferentially selected from a learning data group having a small time difference from the input data group 105. In a case where the weighting of Calculation Method 2 or 3 is used, the learning data is preferentially selected from a learning data group similar to the distribution of the input data group 105 in the feature amount space. It should be noted that Calculation Methods 1, 2, and 3 may be combined.

In the first embodiment, the selection index (weighting) of the sampling is calculated based on the distribution characteristic of the input data group 105. Through selection of the learning data based on the weighting, the inference model can be generated by using a learning data group having a similar distribution characteristic to the input data group 105. Therefore, the inference model can perform inference with a high accuracy for the input data group 105.

The processing step of Step S205 has been described above.

Next, the preprocessing module 110 determines whether or not processing is complete for all groups (Step S206).

In a case where it is determined that processing is not complete for all groups, the process returns to Step S204 and the preprocessing module 110 performs the same processing.

In a case where it is determined that processing is complete for all groups, the preprocessing module 110 executes sampling based on the weighting (Step S207), and then the preprocessing module 110 ends the preprocessing.

Specifically, the sampling module 133 stochastically selects a predetermined number of pieces of learning data based on the weighting and the number of samples. For example, the sampling module 133 selects a predetermined number of pieces of learning data in the manner illustrated in FIG. 6B.

Through stochastic selection of the learning data, the learning data is not selected from only a group of a specific time series. As a result, bias in the learning data and overfitting to specific learning data can be prevented.

FIG. 7 is a flowchart for illustrating an example of learning processing to be executed by the learning module 111 in the first embodiment.

The learning module 111 generates a learning data set from the learning data selected by the preprocessing module 110 (Step S301).

Next, the learning module 111 obtains information on the learning algorithm from the setting information 120 (Step S302).

Next, the learning module 111 generates an inference model by executing machine learning using the learning algorithm and the learning data set (Step S303). As the machine learning, a known method may be used, and therefore a detailed description thereof is omitted here.

Next, the learning module 111 stores the generated inference model in the inference model information 122 (Step S304). The learning module 111 then ends the learning processing.

For example, the learning module 111 overwrites the inference model stored in the inference model information 122 with the new inference model. Further, the learning module 111 may store a plurality of inference models in the inference model information 122.

FIG. 8 is a flowchart for illustrating an example of inference processing to be executed by the inference module 112 in the first embodiment.

The inference module 112 obtains the inference model from the inference model information 122 (Step S401). In a case where a plurality of inference models are stored in the inference model information 122, the newly generated inference model is obtained.

Next, the inference module 112 inputs each piece of input data included in the input data group 105 to the inference model and outputs the inference result obtained from the model by the inference result output module 113 (Step S402). The inference result may be output to an apparatus or system (not shown), or may be output to a terminal operated by the user.

FIG. 9 is a flowchart for illustrating an example of action result obtaining processing to be executed by the action result obtaining module 114 in the first embodiment.

The action result obtaining module 114 obtains the action result (Step S501).

The action result is obtained from the apparatus or system which has output the inference result, or the terminal operated by the user.

The action result obtaining module 114 generates learning data from the input data and the action result for the input data, and stores the generated learning data in the learning data management information 121 (Step S502). Then, the action result obtaining module 114 ends the action result obtaining processing.

As described above, the computer system 100 of the first embodiment calculates the weighting of the learning data groups based on the similarity between a characteristic of the input data group to be inferred and a characteristic of the learning data groups grouped in predetermined time widths. Through generation of the inference model by using the learning data selected through use of the weighting, a highly accurate inference result can be obtained for the input data. In addition, the time required for learning can be greatly reduced.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system, comprising:
at least one computer including a processor, a storage device coupled to the processor, and an interface coupled to the processor,
the computer system being configured to manage a data set of learning data including a value of an explanatory variable and a value of a response variable, and a model for outputting a predicted value of the response variable from the value of the explanatory variable,
the at least one computer being configured to:
generate, in a case where a plurality of pieces of input data including the value of the explanatory variable and forming a time series are received, groups by arranging a plurality of pieces of the learning data included in the data set in time-series order and grouping the plurality of pieces of the learning data in predetermined time widths;
execute, for each of a plurality of the groups, index calculation processing of calculating a selection index of sampling of the learning data;
select the plurality of pieces of the learning data from the data set based on the selection index;
learn the model by using the selected plurality of pieces of the learning data; and
output a predicted value of each of the plurality of pieces of input data by using the model,
the at least one computer is configured to, in the index calculation processing:
calculate the selection index based on a similarity between a distribution characteristic in a feature amount space of the plurality of pieces of input data and a distribution characteristic in the feature amount space of the plurality of pieces of the learning data included in the group; and
add the selection index to each of the plurality of pieces of the learning data included in the group.

2. The computer system according to claim 1, wherein, in the index calculation processing, the at least one computer is configured to calculate the selection index based on a difference between a time of one of the plurality of pieces of input data and a time of the learning data.

3. The computer system according to claim 1, wherein, in the index calculation processing, the at least one computer is configured to:
select a plurality of pieces of representative learning data from the plurality of pieces of the learning data included in the group;
generate a pair of one of the plurality of pieces of input data and one of the plurality of pieces of representative learning data;
calculate a correlation coefficient between the one of the plurality of pieces of input data and the one of the plurality of pieces of representative learning data forming the pair; and
calculate the selection index based on a plurality of the correlation coefficients.

4. The computer system according to claim 1, wherein, in the index calculation processing, the at least one computer is configured to:
select a plurality of pieces of representative learning data from the plurality of pieces of the learning data included in the group;
generate a classification model for classifying whether input data is one of the plurality of pieces of input data or the learning data by using the plurality of pieces of input data and the plurality of pieces of representative learning data; and
calculate the selection index based on an output obtained by inputting the plurality of pieces of representative learning data to the classification model.

5. The computer system according to claim 1, wherein the at least one computer is configured to stochastically select the plurality of pieces of the learning data from the data set based on the selection index.

6. An inference method to be executed by a computer system,
the computer system including at least one computer including a processor, a storage device coupled to the processor; and an interface coupled to the processor,
the computer system being configured to manage a data set of learning data including a value of an explanatory variable and a value of a response variable, and a model for outputting a predicted value of the response variable from the value of the explanatory variable,
the inference method including:
a first step of generating, by the at least one computer, in a case where a plurality of pieces of input data including the value of the explanatory variable and forming a time series are received, groups by arranging a plurality of pieces of the learning data included in the data set in time-series order and grouping the plurality of pieces of the learning data in predetermined time widths;
a second step of executing, by the at least one computer, for each of a plurality of the groups, index calculation processing of calculating a selection index of sampling of the learning data;
a third step of selecting, by the at least one computer, the plurality of pieces of the learning data from the data set based on the selection index;
a fourth step of learning, by the at least one computer, the model by using the selected plurality of pieces of the learning data; and
a fifth step of outputting, by the at least one computer, a predicted value of each of the plurality of pieces of input data by using the model,
the second step including:
a sixth step of calculating, by the at least one computer, the selection index based on a similarity between a distribution characteristic in a feature amount space of the plurality of pieces of input data and a distribution characteristic in the feature amount space of the plurality of pieces of the learning data included in the group; and
a seventh step of adding, by the at least one computer, the selection index to each of the plurality of pieces of the learning data included in the group.

7. The inference method according to claim 6, wherein the sixth step includes calculating, by the at least one computer, the selection index based on a difference between a time of one of the plurality of input data and a time of the learning data.

8. The inference method according to claim 6, wherein the sixth step includes the steps of:
selecting, by the at least one computer, a plurality of pieces of representative learning data from the plurality of pieces of the learning data included in the group;
generating, by the at least one computer, a pair of one of the plurality of pieces of input data and one of the plurality of pieces of representative learning data;
calculating, by the at least one computer, a correlation coefficient between the one of the plurality of pieces of input data and the one of the plurality of pieces of representative learning data forming the pair; and
calculating, by the at least one computer, the selection index based on a plurality of the correlation coefficients.

9. The inference method according to claim 6, wherein the sixth step includes the steps of:
selecting, by the at least one computer, a plurality of pieces of representative learning data from the plurality of pieces of the learning data included in the group;
generating, by the at least one computer, a classification model for classifying whether input data is one of the plurality of pieces of input data or the learning data by using the plurality of pieces of input data and the plurality of pieces of representative learning data; and
calculating, by the at least one computer, the selection index based on an output obtained by inputting the plurality of pieces of representative learning data to the classification model.

10. The inference method according to claim 6, wherein the third step includes stochastically selecting, by at least one computer, the plurality of pieces of the learning data from the data set based on the selection index.

11. A non-transitory machine-readable medium having stored thereon a program for causing a computer to execute the following steps,
the computer including:
a processor;
a storage device coupled to the processor; and
an interface coupled to the processor,
the computer being configured to manage a data set of learning data including a value of an explanatory variable and a value of a response variable, and a model for outputting a predicted value of the response variable from the value of the explanatory variable,
the program causing the computer to execute:
a first step of generating, in a case where a plurality of pieces of input data including the value of the explanatory variable and forming a time series are received, groups by arranging a plurality of pieces of the learning data included in the data set in time-series order and grouping the plurality of pieces of the learning data in predetermined time widths;
a second step of executing, for each of a plurality of the groups, index calculation processing of calculating a selection index of sampling of the learning data;
a third step of selecting the plurality of pieces of the learning data from the data set based on the selection index;
a fourth step of learning the model by using the selected plurality of pieces of the learning data; and
a fifth step of outputting a predicted value of each of the plurality of pieces of input data by using the model,
the second step including:
a sixth step of calculating the selection index based on a similarity between a distribution characteristic in a feature amount space of the plurality of pieces of input data and a distribution characteristic in a feature amount space of the plurality of pieces of the learning data included in the group; and
a seventh step of adding the selection index to each of the plurality of pieces of the learning data included in the group.
